(19) United States
(12) Patent Application Publication
(10) Pub. No.: US 2012/0274590 A1
(43) Pub. Date: Nov. 1, 2012

(54) TOUCH SCREEN AND TOUCH SCREEN DRIVE METHOD

(76) Inventors: Jianjun Liu, Beijing (CN); Xinlin Ye, Beijing (CN); Xinbin Liu, Beijing (CN)

(21) Appl. No.: 13/512,191

(22) PCT Filed: Nov. 25, 2010
(86) PCT No.: PCT/CN2010/079134

§ 371 Date: May 25, 2012

(30) Foreign Application Priority Data
Nov. 27, 2009 (CN) 200910249866.5

(51) Int. Cl. G06F 3/041

(52) U.S. Cl. 345/173

(57) ABSTRACT

The present invention discloses a touch screen and a driving method for the same, the touch screen including: a touch detection area, a processing unit, emission tubes and reception tubes, the emission tubes and the reception tubes being located at the edge of the touch detection area to provide infrared to form a scanning grid, the touch screen also including a background light source which provides auxiliary light to the infrared. The present invention also discloses a corresponding driving method for the touch screen. The touch screen and the driving method for the same of the present invention may reduce the impact of the dark environment on the period required for the received signal in the touch screen to reach stability.

### TECHNICAL FIELD

The present invention relates to the field of interactive display, and particularly to a touch screen and a driving method for the same.

### DESCRIPTION OF THE RELATED ART

In the prior art, there are mainly two kinds of touch screens using photoelectricity technology for touch point detection: one being an infrared touch screen using arrays of infrared emission and reception tubes to constitute an infrared scanning grid, and the other being an optical touch screen using an optical sensing unit, like a camera, as a detection component.

Generally, the application of the infrared touch screen covers from indoor low illumination to outdoor strong light environment. It is found in practice that in case of different environment light intensity, the received signal of the reception tube reaches stability at different time. FIG. 1 shows a schematic diagram of a received signal on reception tubes in case of sufficient light in the prior art, and FIG. 2 shows a schematic diagram of a received signal on reception tubes in case of insufficient light in the prior art. As shown in FIG. 1 and FIG. 2, in case of very dark environment or even no light, the period in which the received signal of the reception tube in the infrared touch screen reaches stability is prolonged, which is reflected by the slowly increasing signal of the reception tube when the emission tube works, especially in large-size products. This phenomenon, on the one hand, causes the reliability of the infrared touch screen to become worse in a dark environment, thus limiting the application of the infrared touch screen, and on the other hand, will cause emission tubes to prolong their working duration so as to make the received signal of the reception tubes have enough time to reach a predetermined value; the latter is prone to shorten the life of the emission tubes on the premise of achieving an intended effect. As a result, there is a need for a touch screen which may shorten the period required for the received signal to reach stability in a dark environment.

### SUMMARY OF THE INVENTION

The present invention provides a touch screen, which may have a short period required for a received signal to reach stability even in a dark environment. The present invention also provides a driving method for the touch screen, which makes the touch screen have a short period required for a received signal to reach stability even in a dark environment.

The touch screen proposed in the present invention comprieses: a touch detection area, a processing unit, emission tubes and reception tubes, the emission tubes and the reception tubes being located at the edge of the touch detection area to provide infrared to form a scanning grid. The touch screen further includes a background light source which provides auxiliary light to the infrared.

Optionally, the touch screen also includes a monitoring unit for monitoring brightness of areas adjacent to the infrared and starting the background light source when the brightness is lower than a standard value.

Optionally, the background light source is one of a point light source, a line light source, or an area light source, or a combination thereof. The background light source is close to the emission tubes or the reception tubes.

Optionally, the background light source contains at least two working groups, each working group containing at least one point light source, line light source or area light source; the respective working groups operate alternately.

Optionally, the background light source contains at least one point light source which is located between the emission tubes and/or between the reception tubes.

Optionally, the background light source is part of the emission tubes, and the intensity of infrared provided by emission tubes acting as the background light source is less than the intensity of the infrared forming the scanning grid.

Optionally, the emission tubes acting as the background light source are near to the emission tubes forming the scanning grid.

The present invention further provides a driving method for a touch screen, compriing: starting the emission tubes and the reception tubes to provide infrared to form a scanning grid; and turning on the background light source to provide auxiliary light to the infrared.

Optionally, the driving method also includes monitoring brightness of areas adjacent to the infrared and turning on the background light source when the brightness is lower than a standard value.

Optionally, the step of turning on the background light source includes: dividing the background light source into at least two working groups, each working group containing at least one point light source, line light source or area light source; operating respective working groups alternately.

Optionally, the step of turning on the background light source includes: determining emission tubes for forming the infrared; operating other emission tubes to provide the background light source, the intensity of infrared provided by said other emission tubes acting as the background light source being less than the intensity of the infrared forming the scanning grid.

Optionally, said other emission tubes are near to the emission tubes forming the scanning grid.

Compared with existing technologies, the touch screen and the driving method for the same provided by the present invention have the following advantages:

The touch screen provided by the present invention, by adding the background light source to provide auxiliary light to the infrared, may reduce the impact of the dark environment on the period required for the received signal in the touch screen to reach stability.

The touch screen provided by the present invention, by using the monitoring unit to monitor brightness of areas adjacent to the infrared and starting the background light source when the brightness is lower than a standard value, or by dividing the background light source into at least two working groups and making the respective working groups operate alternatively, may reduce power consumption on the premise of reducing the impact of the dark environment on the period required for the received signal to reach stability.

The touch screen provided by the present invention, by using a part of the emissions tubes as the background light source, may use the original touch screen to provide the background light source without the need for changing the structure of the background light source, thereby reducing design costs, and further, by using the emission tubes adjacent to the emission tubes forming the scanning grid as the background light source, may reduce power consumption on the premise of reducing design costs.

The driving method for the touch screen provided by the present invention, by turning on the background light source to provide auxiliary light to the infrared, may reduce the impact of the dark environment on the period required for the received signal in the touch screen to reach stability.

The driving method for the touch screen provided by the present invention, by monitoring brightness of areas adjacent to the infrared and starting the background light source when the brightness is lower than a standard value, or by dividing the background light source into at least two working groups, and operating the working groups alternatively, may reduce power consumption on the premise of reducing the impact of the dark environment on the period required for the received signal to reach stability.

The driving method for the touch screen provided by the present invention, by determining emission tubes for forming the infrared and operating other emission tubes to provide the background light source, may use the original touch screen to provide the background light source without the need for changing the structure of the background light source, thereby reducing design costs, and further, by using the emission tubes adjacent to the emission tubes forming the scanning grid as the background light source, may reduce power consumption on the premise of reducing design costs.

### BRIEF DESCRIPTION OF THE DRAWINGS

FIG. 1 is a schematic diagram of a received signal on reception tubes in case of sufficient light in the prior art;

FIG. 2 is a schematic diagram of a received signal on reception tubes in case of insufficient light in the prior art;

FIG. 3 is a schematic diagram of a first embodiment of a touch screen of the present invention;

FIG. 4 is a schematic diagram of another embodiment of the touch screen of the present invention;

FIG. 5 is a schematic diagram of a second embodiment of the touch screen of the present invention; and

FIG. 6 is a schematic diagram of yet another embodiment of the touch screen of the present invention.

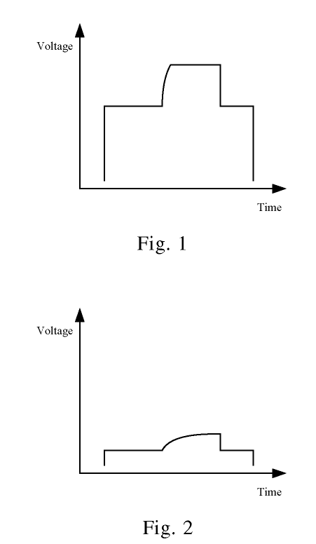

### DETAILED DESCRIPTION OF THE PREFERRED EMBODIMENT

The present invention will be further described below in conjunction with the attached drawings and detailed description of the preferred embodiments.

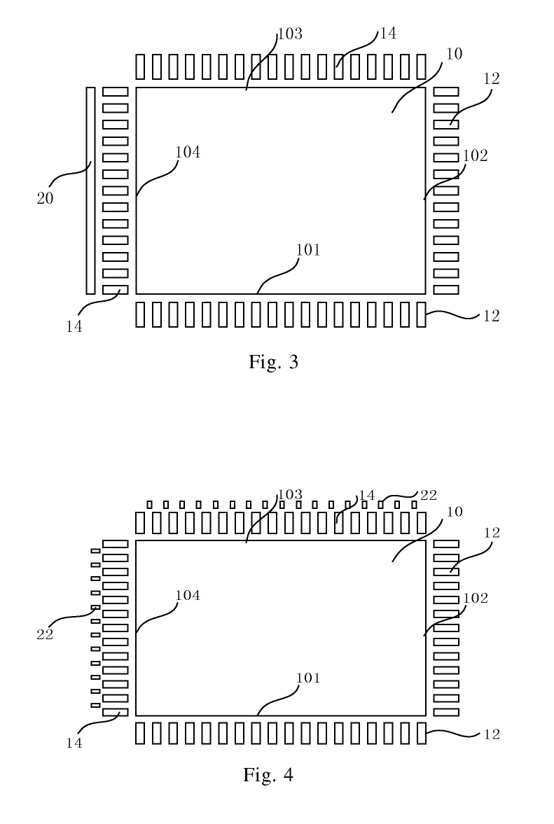

As shown in FIG. 3, in a first embodiment of a touch screen of the present invention, the touch screen includes a touch detection area 10, a processing unit, emission tubes 12 and reception tubes 14. The emission tubes 12 and reception tubes 14 are located at the edge of the touch detection area 10 to provide infrared, thereby forming a scanning grid. It should be noted that the emission tubes 12 and the reception tubes 14 may be at least two in number, and the correspondence relationship between them may be one-to-one correspondence, and may be one emission tube 12 corresponding to at least two reception tubes 14, or one reception tube 14 corresponding to at least two emission tubes 12. FIG. 3 merely shows an example when the emission tubes 12 and the reception tubes 14 both may be at least two and they correspond to each other one-to-one. In other embodiments, the number of the emission tubes 12 and reception tubes 14 as well as the correspondence relationship therebetween can be selected based on actual needs, which is also applicable to subsequent embodiments and no more description will be given.

The processing unit in the touch screen is used to drive the touch screen (including control the on or off of the emission tubes 12 and reception tubes 14), and obtain touch data by means of an algorithm contained therein. Software controlling the algorithm may be programmed by different programmers in various forms and programming languages.

In addition, the touch screen also includes a background light source 20 which provides auxiliary light to the infrared. After analysis, the inventor believes that the use of the auxiliary light to compensate insufficient ambient light in a dark environment will help reduce the impact of the dark environment on the time required for the received signal in the touch screen to reach stability.

In this embodiment, the background light source 20 may be close to the reception tubes 14 and is located outside the region surrounded by the emission tubes 12 and reception tubes 14. The background light source 20 may be a line light source, such as infrared tubular light source; and the number of the line light source may be one.

In other embodiments related to this first embodiment, the background light source 20 may be located within the region surrounded by the emission tubes 12 and reception tubes 14 and be close to the reception tubes 14; or the background light source 20 may be located inside or outside the region surrounded by the emission tubes 12 and reception tubes 14 and be close to the emission tubes 12; or the background light source 20 may be attached above or below to the emission tubes 12 and/or reception tubes 14.

In other embodiments related to this first embodiment, the background light source 20 may contain at least two line light source groups. Each of the line light source groups contains at least one line light source, and the respective line light source groups operate alternately. Operating alternately means that the line light sources are started sequentially, and at any moment, there is always part of the line light sources emitting auxiliary light, but there is also part of the line light sources not emitting auxiliary light. Thus, on the premise of reducing the impact of the dark environment on the response time of the received signal in the touch screen, power consumption is reduced. The specific order of operation is determined by using the processing unit according to actual needs.

In other embodiments related to this first embodiment, the background light source 20 may be a point light source or area light source, or any combination of a point light source, a line light source and an area light source. The point light source may be a light-emitting diode or cold cathode fluorescent lamp. The area light source may be an electroluminescent element. The number of either the point light source or the area light source may be at least one. The point light source may also be located between the emission tubes 12 and/or between the reception tubes 14. The background light source 20 may contain at least two working groups, each of the working groups containing at least one point light source or area light source, or being any combination of the point light source, line light source, and area light source. The working groups may operate alternately.

It should be noted that, generally, the touch detection area has four edges, denoted as a first edge 101, a second edge 102, a third edge 103 and a fourth edge 104, respectively. Usually, the first edge 101 and the second edge 102 are provided with the emission tubes 12, and the third edge 103 and the fourth edge 104 are provided with the reception tubes 14. In the above embodiments of the touch screen, when the background light source is a line light source or area light source, the background light source may be placed at one of the four edges, for example, placed at the third edge 103 or at the first edge 101; it may also be placed concurrently at two edges provided with the emission tubes 12 or reception tube 14, for example, concurrently placed at the first edge 101 and second edge 102 provided with the emission tubes 12 or concurrently placed at the third edge 103 and fourth edge 104 provided with the reception tubes 14. In addition, the background light source may also be placed concurrently at three or four of the four edges, which can be specifically selected according to actual needs. FIG. 3 shows an example of the line light source being placed at the fourth edge provided with the reception tubes 14.

When the background light source is constituted by point light sources, by taking into account emission concentration of the point light sources, preferably, the point light sources are placed concurrently at two edges provided with the emission tubes 12 or reception tubes 14, for example, placed concurrently at the first edge 101 and second edge 102, or placed concurrently at the third edge 103 and fourth edge 104; or they may be placed concurrently at the above four edges. FIG. 4 shows an example of the point light sources 22 being placed concurrently at the two edges 103 and 104 provided with the reception tubes 14. In FIG. 4, the point light sources 22 are located outside the region surrounded by the emission tubes 12 and reception tubes 14, which is applicable to subsequent embodiments and no more description will be given.

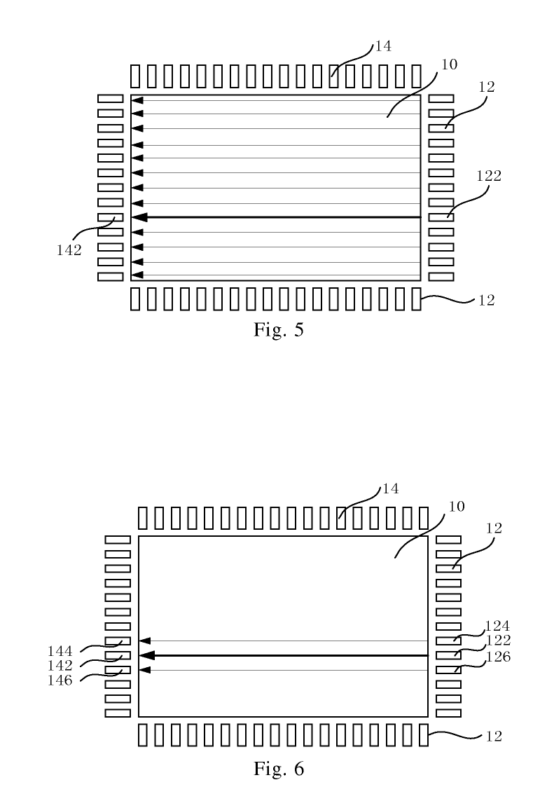

As shown in FIG. 5, in a second embodiment of the touch screen of the present invention, the touch screen includes a touch detection area 10, a processing unit, emission tubes 12 and reception tubes 14. The emission tubes 12 and reception tubes 14 are located at the edge of the touch detection area 10 to provide infrared, thereby forming a scanning grid; the intensity of infrared provided by part of the emission tubes 12 is less than the intensity of the infrared forming the scanning grid. As an example, in FIG. 5, the intensity of infrared emitted by the emission tubes 122 and received by the reception tubes 142 is higher than the intensity of infrared emitted by other emission tubes 12. Various embodiments of the present invention take the emission tubes 12 and reception tubes 14 which correspond to each other one-to-one as an example; however, the intensity arrangement is applicable to the emission tubes 12 and reception tubes 14 which have other correspondence relationships, and no more description will be given.

Here, the emission tubes of the original touch screen are used to provide the background light source 20, without the need for changing the structure of the background light source 20, thereby reducing design costs.

Specifically, it simply needs to adjust the driving program of the processing unit. That is, at any moment, after determining the emission tubes 122 to provide infrared for the formation of the scanning grid, other emission tubes are adjusted, so that the intensity of the infrared provided thereby is less than the intensity of the infrared forming the scanning grid.

In particular, in other embodiments related to this second embodiment, as shown in FIG. 6, only the emission tubes 124 and 126 adjacent to the emission tubes 122 forming the scanning grid are used as the background light source. By using the emission tubes 124 and 126 adjacent to the emission tubes 122 forming the scanning grid as the background light source, power consumption can be reduced on the premise of reducing design costs.

Based on the first embodiment, the second embodiment and other embodiments related with the two, as a third embodiment of the present invention, the touch screen may also include a monitoring unit for monitoring brightness of areas adjacent to the infrared and starting the background light source when the brightness is lower than a standard value.

Specifically, the monitoring unit may be any commercially available optical detector; the standard value may be determined flexibly according to actual needs. The monitoring unit may be coupled to the processing unit, so that the driving program of the processing unit may be timely adjusted using monitoring results. Thus, power consumption may be reduced on the premise of reducing the impact of the dark environment on the period required for the received signal in the touch screen to reach stability.

The present invention also provides a driving method applied to a touch screen. In a first embodiment of the driving method, the driving method includes:

Step 21: Starting the emission tubes and reception tubes for providing infrared to form a scanning grid;

Step 22: Turning on the background light source to provide auxiliary light to the infrared.

The processing unit may be used to control on or off of the emission tubes, reception tubes and background light source. By turning on the background light source to provide auxiliary light to the infrared, the impact of the dark environment on the period required for the received signal in the touch screen to reach stability may be reduced.

Specifically, step 22 includes:

Step 221: dividing the background light source into at least two working groups, each working group containing at least one point light source, line light source or area light source;

Step 222: alternately operating the working groups.

Each working group contains at least one point light source, line light source, or area light source, or may be any combination of the point light source, line light source and area light source. The working groups are alternately operated, and thus, power consumption may be reduced on the premise of reducing the impact of the dark environment on the period required for the received signal in the touch screen to reach stability.

In addition, in the second embodiment of the driving method, the step 22 may include:

Step 223: determining emission tubes for forming the infrared;

Step 224: operating other emission tubes to provide the background light source, such that the intensity of infrared provided by said other emission tubes is less than the intensity of the infrared forming the scanning grid.

In particular, said other emission tubes may be emission tubes near to the emission tubes forming the scanning grid.

By using the original touch screen to provide the background light source without the need for changing the structure of the background light source, design costs may be reduced; and further, by using the emission tubes adjacent to the emission tubes forming the scanning grid as the background light source, power consumption may be reduced on the premise of reduced design costs.

Based on the first embodiment, the second embodiment and other embodiments related with the two of the driving method, as a third embodiment of the driving method of the present invention, before turning on the background light source, the driving method also includes:

Step 212: monitoring brightness of areas adjacent to the infrared and turning on the background light source when the brightness is lower than a standard value.

Thus, power consumption may be reduced on the premise of reducing the impact of the dark environment on the period required for the received signal in the touch screen to reach stability.

The method of the present invention is not limited to the embodiments described in the Detailed Description of Preferred Embodiments. Other embodiments acquired by those skilled in the art based on the technical solutions of the invention also belong to technical innovation scope of the invention.

1. A touch screen, comprising: emission tubes and reception tubes and a processing unit for driving the emission tubes and the reception tubes, the emission tubes and the reception tubes being located at the edge of a touch detection area to provide infrared a scanning grid, characterized in that the touch screen also includes a background light source which provides auxiliary light to the infrared.

2. The touch screen according to claim 1, characterized in that the touch screen also includes a monitoring unit for monitoring brightness of areas adjacent to the infrared and turning on the background light source when the brightness is lower than a standard value.

3. The touch screen according to claim 1 or 2, characterized in that the background light source is one of a point light source, a line light source and an area light source, or a combination thereof, and the background light source is close to the emission tubes or the reception tubes.

4. The touch screen according to claim 3, characterized in that the background light source contains at least two working groups, each of the working groups containing one of the point light source, line light source and area light source, or a combination thereof, and the working groups are alternately operated.

5. The touch screen according to claim 1 or 2, characterized in that the background light source contains at least one point light source which is located between the emission tubes and/or between the reception tubes.

6. The touch screen according to claim 1 or 2, characterized in that a part of the emission tubes acts as the background light source, and the intensity of infrared provided by emission tubes acting as the background light source is less than the intensity of the infrared forming the scanning grid.

7. The touch screen according to claim 6, characterized in that the emission tubes acting as the background light source are near to the emission tubes for forming the scanning grid.

8. A driving method for the touch screen according to claim 1, comprising: turning on the emission tubes and the reception tubes to provide infrared to form a scanning grid; and turning on the background light source to provide auxiliary light to the infrared.

9. The driving method according to claim 8, further including monitoring brightness of areas adjacent to the infrared and turning on the background light source when the brightness is lower than a standard value.

10. The driving method according to claim 8 or 9, characterized in that the step of turning on the background light source includes: dividing the background light source into at least two working groups, each working group containing one of point light source, line light source and area light source, or a combination thereof; operating the working groups alternately.

11. The driving method according to claim 8 or 9, characterized in that the step of turning on the background light source includes: determining emission tubes for forming the infrared; operating other emission tubes to provide the background light source, wherein the intensity of infrared provided by said other emission tubes acting as the background light source is less than the intensity of the infrared forming the scanning grid.

12. The driving method according to claim 11, characterized in that said other emission tubes are near to the emission tubes forming the scanning grid.
